(19) United States
(12) Patent Application Publication
(10) Pub. No.: US 2012/0037639 A1
(43) Pub. Date: Feb. 16, 2012

(54) Interchangeable Pan

(76) Inventors: Teddy Gotsis, Hillside, NJ (US); Angelo Gotsis, Hillside, NJ (US)

(21) Appl. No.: 13/276,567

(22) Filed: Oct. 19, 2011

Related U.S. Application Data
(63) Continuation-in-part of application No. 13/204,190, filed on Aug. 5, 2011.
(60) Provisional application No. 61/370,850, filed on Aug. 5, 2010.
(60) Provisional application No. 61/381,630, filed on Sep. 10, 2010.

(51) Int. Cl. A47J 27/00

(52) U.S. Cl. 220/573.4

(57) ABSTRACT

A pan and frame system is described that allows one frame to be used interchangeably with a variety of pans for cooking, thus allowing the user flexibility in use. The system cooks a range of foods, and allows one such varied options as stir frying or making toast over a heat source. The system is easy to use, the pans are easy to install and remove from the frame, and the frame with a set of pans is useful in a small space where storage is limited.

### CLAIM OF PRIORITY

This application claims the priority of U.S. Ser. No. 61/370,850 filed on Aug. 5, 2010, U.S. Ser. No. 61/381,630 filed on Sep. 10, 2010, and U.S. Ser. No. 13/204,190 filed on Aug. 5, 2011, the contents of which are fully incorporated herein by reference.

### FIELD OF THE INVENTION

The present invention relates to cooking utensils, specifically to cooking pans.

### BACKGROUND OF THE INVENTION

Many different types of pans exist for varying cooking purposes. Cooks may have a plethora of pans in their kitchens, all of which take up space. This can be an issue in small kitchens, such as those found in many apartments and small houses. Stacking pans inside each other may destroy a non-stick surface if they are shuffled around and scrape one another. In addition, if a cook uses multiple pans during the preparation of a meal, the kitchen may become littered with dirty pans that must be cleaned to make room. If one pan is used repeatedly, it preferably must be cleaned between uses, which takes time away from meal preparation such that one cooked food gets cold while the cook is waiting to prepare the next item in the pan.

Attempts have been made to alleviate some of the problems cited above; examples of the prior art are below.

U.S. Pat. No. 6,082,249 discloses a multi-purpose cooker including a base having a circular top formed with a plurality of equidistant holes, a heating seat having a bottom formed with a plurality of downwardly extending pins engageable with the holes, a heating member mounted within the heating seat and provided with a switch and a control button on an outer side of the heating seat, a frying pan configured to be mounted on the heating seat and provided with a plurality of slots for passage of oil so as to prevent food from sticking the frying pan, a barbecue grill provided with a plurality of supporting legs adapted to be arranged on the heating seat for roasting food, a circular tray having an annular recess and a central portion formed with a projection, a pot having a bottom formed with a cavity configured to engage with the projection, and a plurality of condiment trays configured to be fitted in the annular recess of the circular tray.

U.S. Pat. Nos. 6,293,271 and 6,718,966 disclose a cooking pot which includes a base portion and a removable cover therefore. An annular lip of the pot is formed with at least one vent opening therein. Airflow between ambient and a cooking chamber defined within the pot is adjustable by rotating the cover relative to the base portion. The cooking pot is also multifunctional in that it is operable in any one of a plurality of cooking modes including but not limited to an open charcoal-grilling mode, a closed charcoal-grilling mode, an externally-heated charcoal-grilling mode, a grilling and smoking mode, a deep-frying mode, a boiling and simmering mode, a steaming mode, and oven modes.

US Patent Application 20060027106 discloses an apparatus for holding multiple pizzas including a pan and an insert adapted to fit within the pan. The insert includes a plurality of sidewalls extending between a base of the insert and an upper portion of the insert, and the sidewalls generally surround a plurality of openings defined by the insert in the base. The insert is adapted to fit within the pan such that each of the multiple pizzas contacts a bottom of the pan and the sidewalls of the insert. A method of making multiple pizzas includes placing a support into a cooking vessel, placing dough across the support to form multiple dough portions, placing ingredients on the multiple dough portions to form multiple pizzas, and placing the support and the cooking vessel into a heating environment to bake the multiple pizzas.

US Patent Application 20070289983 discloses a removable cooking container for use with one pot and pan to eliminate time-consuming task of cleaning such pots and/or pans. The cooking container comprises a reusable holder having a first portion capable of fitting within at least one of the pot and/or pan and a second portion capable of extending out from the pot and/or pan. A preformed heavy-duty aluminum disposable insert is provided which is capable of being positioned within and held by the holder. The insert is capable of holding food for cooking within the pot and/or pan. A handle is attached to the second portion of the holder for removing the holder and the insert from the pot and/or pan. Upon completion of cooking, the food is removed from the cooking container and the insert is simply removed from the holder and disposed of, significantly reducing the time needed for cleaning messy pots and/or pans and eliminating the chance of scratching and/or marring the surface of such pots and/or pans due to scrubbing.

PCT International Patent Application WO 96/10942 discloses a multi-purpose pan-stove consisting of a heating pan, a cooking pan which fits into the heating pan, and accessories, which allows one to carry out various cooking operations. It can function as a stove, a frying pan, a grill, a braai, a chinese wok, a poacher, a steamer, a fondu, a chip fryer or a baker, and with some small modifications it can even be used as a pressure cooker. The heating pan contains a heating device such as an electric element or a gas burner. Protrusions are pressed into its side wall just above the heating element, for air ventilation and to act as support. The main accessories are a lid, a grid, a frying basket, a chinese wok, a pan with large openings in the bottom into which fit small cups and a steamer plate with small holes and a divider. For grilling, the grid is put on the bottom of the cooking pan and the heating pan is put upside down on the cooking pan, else the cooking pan is installed into the heating pan and rests on the protrusions and whenever necessary the lid is put on top of the cooking pan. For poaching eggs, the pan with large openings is put into the cooking pan and the small cups are placed in the large openings. For steaming, the disc with small holes is led down upon the bottom of the pan with large openings.

European Patent Application EP 2 140 786 discloses a cooking utensil comprising a frame having a base with recess. The cooking utensil may be adapted for receiving a removable and/or exchangeable bottom for closing the recess in the base, and fixing means for removably fixing the removable and/or exchangeable bottom to base of the frame. An advantage of cooking utensil according to embodiments of the invention is that when a cooking surface of the cooking utensil is damaged, e.g. scratched, the removable and/or exchangeable bottom can be removed and replaced be a new removable and/or exchangeable bottom with undamaged cooking surface. This significantly decreases costs with respect to prior art cooking utensils where the complete cooking utensil has to be replaced when the cooking surface is damaged, e.g. scratched. The present invention also provides a removable and/or exchangeable bottom for use with a cooking utensil according to embodiments of the invention and a method for making such a cooking utensil.

The present invention solves the problems stated above in a unique way by allowing a user to cook various foods using a frame that can accommodate differing pans. One unique feature of the present invention is that a user may not only cook foods traditionally cooked in a stovetop pan, the invention allows a user to toast bread over a stovetop. The present invention allows a user more versatility than with conventional cookware and utensils disclosed in the prior art.

Switching pans is more facile than in the inventions of the prior art; the user may rapidly switch pans during cooking without getting burned by the hot pan. The frame doesn't contact the food being cooked and therefore doesn't need to be cleaned when the pans are switched. This is an advantage over the utensil disclosed in European Patent Application EP 2 140 786 cited above; in EP 2 140 786, the base may be switched but the frame remains an integral part of the pan, such that it gets soiled by food and gets hot, thereby causing the user to have to clean the frame and base both between uses. It also causes the user to have to wait for the frame to cool before switching pans.

The present invention allows a user to cook in a pan inside the frame, then quickly eject the pan into the sink for cleaning and place another pan in the frame immediately for further cooking. This feature is valuable to casual cooks, but also to anyone who must cook quickly, such as cooks in a restaurant or chefs in a contest.

Another advantage of present invention is the unique feature that it can be used as a toaster as well as a variety of pan types, and thus can replace a toaster in a small area where there is limited counter space.

Another venue where the present invention is very useful is in camping, RVing, or traveling, or anytime access to cleaning facilities and space is limited. The pans can be used once each and then stored together for later washing.

### SUMMARY OF THE INVENTION

The present invention is an article of manufacture comprising a frame, having inside and outside edges; a first holding mechanism located on a first portion of the inside edge; a second holding mechanism located on a second portion of the inside edge; a handle, disposed on the frame; at least one pan having a first engagement assembly which may engage the first holding mechanism and a second engagement assembly which may engage the second holding mechanism, wherein the second engagement assembly has open and closed positions and the pan is secured to the frame when the second engagement assembly is in the closed position and the pan may be removed from the frame when the second engagement assembly is in the open position.

The invention is a pan that can be removably disposed inside a frame for cooking. The ease of insertion and removal of the pan in the frame makes cooking with multiple pans quick and easy. It also makes it easier to store multiple pans in a small space; in one embodiment the frame has a foldable handle and the pan has a retractable handle so neither handle protrudes, thus reducing needed storage space. Additionally, the pans and frame can stack together to be stored as a compact unit, thereby freeing up the space that multiple pans would otherwise occupy and making transportation easier.

It is an object of the invention to provide a multiple use cooking article.

It is an object of the invention to provide a frame that can accommodate pans with varying cooking surfaces.

It is an object of the invention to provide a frame and pans that can be easily stored and transported.

It is an object of the invention to provide a frame which allows the user to quickly and easily switch pans.

It is an object of the invention to provide mechanisms such that the frame and a pan are securely and safely engaged while in use.

It is an object of the invention to provide a variety of pans for use with a single frame.

It is an object of the invention to save time while cooking.

It is an object of the invention to provide a pan that can be removably disposed inside a frame for cooking.

### BRIEF DESCRIPTION OF THE DRAWINGS

FIG. 1 is a top perspective view of the frame section of the invention.

FIGS. 2A-2E are top perspective views of the pan section of the invention.

FIG. 3 is a top perspective view of the invention being assembled.

FIG. 4 is a top perspective view of the invention in use.

FIG. 5 is a top exploded view of the handle section of the invention.

FIG. 6 is a top perspective view of the frame in an alternate embodiment.

FIG. 7 is a front view of the invention as stored.

FIG. 8 is a side view of the invention as stored.

FIG. 9 is a perspective view showing an alternate embodiment of the invention having a pan located in a frame, as seen from the logo plate side of the frame.

FIG. 10 is a perspective view showing an alternate embodiment of a frame of the invention with the handle in position for storage.

FIG. 11 is a perspective view showing an alternate embodiment of a pan of the invention.

FIG. 12 is a cross-sectional view showing a locking mechanism of an alternate embodiment of the invention.

FIG. 13 is a perspective close up view showing a handle of an alternate embodiment of the invention.

FIG. 14 is a front view of a set of pans with indentations.

FIG. 15 is a front view of a set of stacked pans with indentations.

FIG. 16 is a back view of a set of stacked pans with indentations.

FIG. 17 is a front perspective view of a handle.

FIG. 18 is a top perspective view of an embodiment of the invention.

FIG. 19 is a cut-away view of a handle.

### DESCRIPTION OF THE PREFERRED EMBODIMENTS

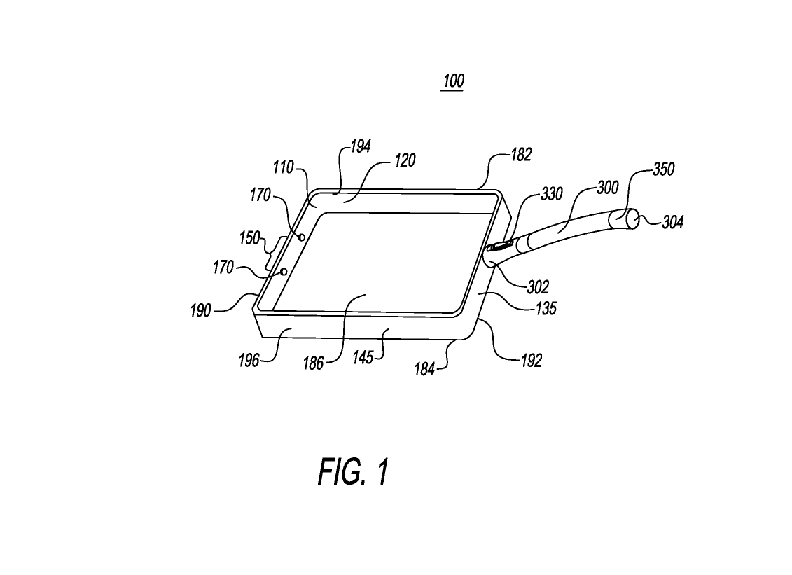

FIG. 1 is a top perspective view of the frame section of the invention. FIG. 1 shows frame 100, frame front inside edge 110, frame right inside edge 120, frame rear outside edge 135, frame left outside edge 145, frame first holding mechanism 150, frame first holding mechanism interlocking pin receiver 170, frame top rim 182, frame bottom rim 184, pan receiving space 186, frame front side 190, frame rear side 192, frame right side 194, frame left side 196, frame handle 300, handle proximate end 302, handle distal end 304, button 330, temperature gauge 350.

In the preferred embodiment shown in FIG. 1, the frame first holding mechanism 150 is at the frame front side 190, and the frame second holding mechanism (not visible) is at the frame rear side 192. In an alternate embodiment, the frame first holding mechanism 150 is at the frame left side 196 and the frame second holding mechanism is at the frame right side 194. In both embodiments, the holding mechanisms are disposed opposite each other, but they may be on the same side or on adjoining sides. There may be one or more holding mechanisms, with two holding mechanisms being preferred, but there may be up to five holding mechanisms on the frame 100.

The frame 100 is shown as a complete rectangular shape, but it can be any shape, including but not limited to, a partial or complete rectangle, partial or complete circle, partial or complete oval, partial or complete square, partial or complete triangle, or any shape or combination of shapes. The complete shape is preferred, but a partial shape may be desired for alternate embodiments. For instance, to make the invention resemble a griddle, the frame may be a rectangular shape constructed with three sides such that food could easily slide into or out of the pan and frame using the open fourth side.

The dimensions may vary for different types of pans, with preferred dimensions of 1 inch to 20 inches length per side, 0.1 inch to 10 inches depth per side, and 1/64 inch to 1 inch thick walls for each side. In the case of a complete circular frame, the diameter may range from 1 inch to 25 inches. One preferred embodiment is to have a complete square shape with dimensions of 12 inches length per side, 2 inches deep on each side, and ⅛ inch thick walls for each side.

The handle is optional but is preferred. The handle may be permanently affixed to any side of the frame or may be detachable. Other features of the handle will be discussed with FIG. 5.

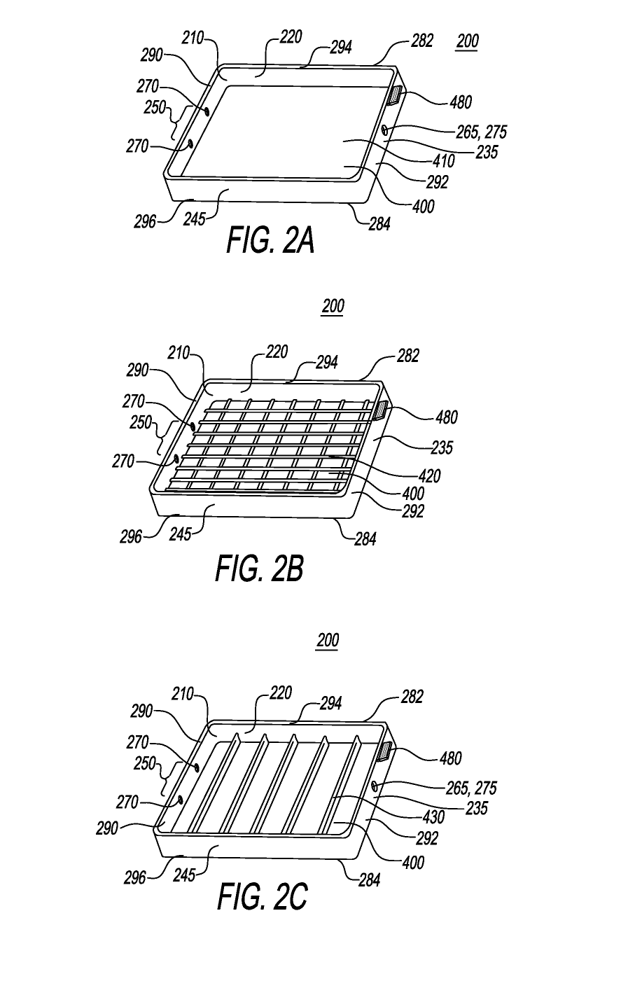

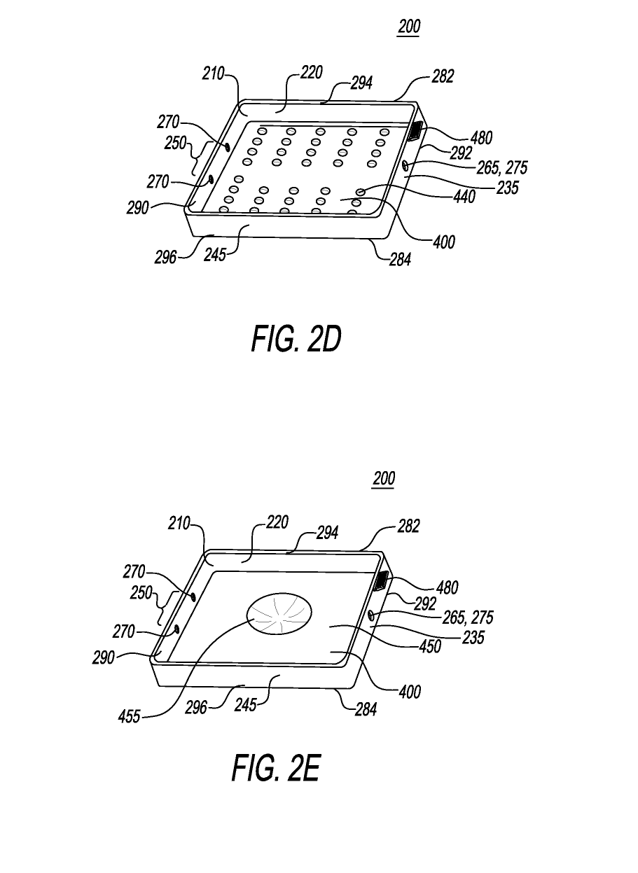

FIGS. 2A-2E are top perspective views of the pan section of the invention. FIGS. 2A-2E all show pan 200, pan front inside edge 210, pan right inside edge 220, pan rear outside edge 235, pan left outside edge 245, pan first engagement assembly 250, pan first engagement assembly interlocking pin 270, pan top rim 282, pan bottom rim 284, pan front side 290, pan rear side 292, pan right side 294, pan left side 296, pan top surface 400, pan handle 480.

In addition, FIGS. 2A and 2C through 2E show pan second engagement assembly 265 and pan second engagement assembly interlocking pin 275.

FIG. 2A shows pan top surface flat surface 410, FIG. 2B shows pan top surface texture surface 420, FIG. 2C shows pan top surface ridged surface 430, FIG. 2D shows pan top surface waffle surface 440, and FIG. 2E shows pan top surface egg surface 450. Although five preferred types of pan surfaces are described here, other types of pan surfaces may be made to use with the frame 100, and combinations of these five types of pan surfaces with each other or with other types of surfaces may be used.

Although not shown, a lid or cover may be used with the invention, either for cooking or storage and transport or both. The same cover may be used for all of the pans, each pan may have its own specific cover, or two or more pans may share a cover. The cover is preferably the same shape and size as the pan or pans, but it may be a different shape or size.

The pan 200 is shown as a rectangular shape, but it can be any shape, including but not limited to, rectangle, circle, square, triangle, or any shape or combination of shapes. In a preferred embodiment, the shape of the pan is the same shape as the frame, with slightly smaller dimensions such that the pan can fit inside the frame. The shapes of the pan and the frame may be differing however, for instance, a user may use a smaller rectangular pan inside a square frame. The dimensions may vary for different types of pans, with preferred dimensions of 1 inch to 20 inches length per side, 0.1 inch to 10 inches depth per side, and 1/64 inch to 1 inch thick walls for each side. In the case of a circular frame, the diameter may range from 1 inch to 25 inches. One preferred embodiment is to have a square shape with dimensions of 11 and 1/16 inches length per side, 1 and 7/16 deep on each side, and ⅛ inch thick walls for each side. These dimensions of the pan are such that the pan can fit inside a frame that is 12 inches long, 2 inches deep, and has ⅛ inch thick walls.

The pan 200 is shown with an optional pan handle 480. In a preferred embodiment, the pan handle 480 is retractable and is made from a non-flammable material, such as but not limited to, silicone rubber or other rubber, metal, glass or glass products, high-temperature plastics, or any other material or combination of materials. The handle is on the pan top rim 282 so that it is easily accessible when cooking. Although shown on the pan rear edge, the handle may be on any edge of the pan and anywhere along the length of the edge. The handle is present to allow the user to easily remove the pan from the frame by providing a lifting surface. The lifting surface may be a handle as shown or may be an extension of the pan top rim, or any other device that aids in removing the pan from the frame.

FIG. 2A shows pan top surface flat surface 410. The flat surface allows a user to cook a food such as pancakes that require full contact with the surface area. It may also be used to stir fry meats and vegetables. In addition, the flat surface may be used to simmer or boil foods.

FIG. 2B shows pan top surface texture surface 440, shown as a grid with holes between the crosshatches. The texture surface allows a user to toast bread or cook any food that benefits from air circulation. This feature distinguishes the invention from many other types of cooking utensils in that it allows a user to use the pan 200 as a toaster. This is especially useful when a toaster or oven is not available, such as when camping, in a small house or apartment, or in living quarters where counter space is limited. The user only needs a hotplate or other heat source with the pan to toast bread.

FIG. 2C shows pan top surface ridged surface 430. The ridged surface allows the user to cook greasy foods or to marinate foods when cooking. This surface provides an effect similar to a grill. The food is suspended on the ridges and the grease or extra marinade runs off and collects in the troughs below. This is especially useful when cooking foods such as bacon, sausages, fatty steaks, chicken, burgers, hotdogs, duck, pork tenderloin, and fish.

FIG. 2D shows pan top surface waffle surface 420. The waffle surface has raised areas as in a traditional waffle pan, so a user can cook a traditional waffle in the pan 200.

FIG. 2E shows pan top surface egg surface 450 with indentation 455. The design of the pan top surface allows a user to break an egg into the indentation and cook it in a confined shape. This also allows the user to cook other foods around the edges of the indentation without mixing them with the egg. For instance, a user may cook sausages or hash browns on the sides of the pan and an egg in the indentation. Although shown in the middle of the pan top surface, the indentation 455 may be anywhere in the pan top surface, for instance off to one side so that other foods are more easily cooked along with the egg. There may be any number of indentations; in a preferred embodiment, there is one indentation.

An example of the invention in use would be when a user is camping and wants to make a hot breakfast. The user would set up a cook stove, assemble the desired pan in the frame and place the assembled invention on the cook stove. He could use pan top surface flat surface 410 to cook pancakes, use pan top surface texture surface 420 to make toast, use pan top surface ridged surface 430 to cook bacon, use pan top surface waffle surface 440 to make waffles, and use pan top surface egg surface 450 to cook eggs and hashbrowns. If he forgot the coffee pot, he could skip the pancakes and boil water in pan top surface flat surface 410 and make instant coffee. The user would then let the pans cool, pack them together, and wash them the next time he's near a clean water source. If he's camping with someone who can't eat a certain food, for instance bacon, he doesn't have to worry about contamination of the other foods with bacon grease left in the pan.

The frame 100 and pans 200 and their components can be made from any material, including but not limited to: metal, including but not limited to aluminum, stainless steel, and copper; glass and glass products, including but not limited to borosilicate, fiberglass and ‘gorilla glass’; plastics; rubbers; textiles; or any material or combinations of these materials with each other or any other materials. The pans 200 may be coated with a non-stick coating such as, but not limited to, Teflon®, or any other material that may be desired as a coating.

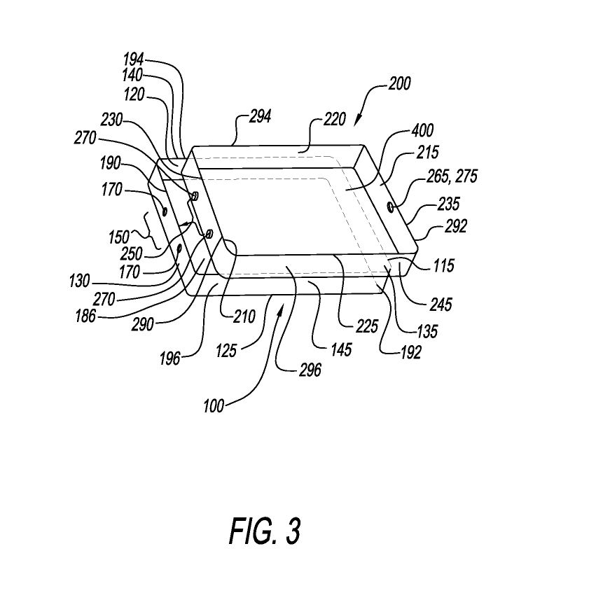

FIG. 3 is a top perspective view of the invention being assembled. FIG. 3 shows frame 100, frame rear inside edge 115, frame right inside edge 120, frame left inside edge 125, frame front outside edge 130, frame rear outside edge 135, frame right outside edge 140, frame left outside edge 145, frame first holding mechanism 150, frame first holding mechanism interlocking pin receiver 170, pan receiving space 186, frame front side 190, frame rear side 192, frame right side 194, frame left side 196.

FIG. 3 also shows pan 200, pan rear inside edge 215, pan right inside edge 220, pan left inside edge 225, pan front outside edge 230, pan rear outside edge 235, pan left outside edge 245, pan first engagement assembly 250, pan second engagement assembly 265, pan first engagement assembly interlocking pin 270, pan second engagement assembly interlocking pin 275, pan front side 290, pan rear side 292, pan right side 294, pan left side 296, pan top surface 400.

As can be seen in FIG. 3, the user slides the pan 200 into the pan receiving space 186 in the frame 100, such that the pan front side 290 contacts the frame front side 190, the pan rear side 292 contacts the frame rear side 192, the pan right side 294 contacts the frame right side 194, and the pan left side 296 contacts the frame left side 196. The frame first holding mechanism 150 has two frame first holding mechanism interlocking pin receivers 170 that correspond to two pan first engagement assembly interlocking pins 270 in the pan first engagement assembly 250. The user engages the frame first holding mechanism interlocking pin receivers 170 with the two pan first engagement assembly interlocking pins 270, thereby securing the pan in the frame.

The user then engages the frame second holding mechanism interlocking pin receiver (not shown) with the pan second engagement assembly interlocking pin 275, further securing the pan 200 in the frame 100. The pan second engagement assembly 265 and the frame second holding mechanism (not shown) comprise a pin and receiver assembly which may be activated by a spring loaded lever. The spring loaded lever allows the user to quickly and easily engage and disengage the pan 200 from the frame 100.

The interlocking pins on all or any of the pan engagement assemblies may be spring loaded so that they collapse when they contact the side of the frame, then expand when engaged with the interlocking pin receivers in the frame.

The frame has a front, rear, and left and right sides, and the in a preferred embodiment, the first holding mechanism is at the front side of the frame and the second holding mechanism is at the rear side of the frame. These holding assemblies correspond to engagement assemblies on the front and rear sides of the pan.

The engagement assemblies and holding mechanisms may be located anywhere on the pan and frame, respectively. There may be any number of engagement assemblies and holding mechanisms on the pan and frame. The engagement assemblies may be on the pan or on the frame, and the holding mechanisms may be on the pan or on the frame.

The number of engagement assemblies preferably matches the number of holding mechanisms, but the numbers of engagement assemblies and holding mechanisms can differ. For instance, a lighter weight pan such as the pan with pan top surface texture surface shown in FIG. 2B may require fewer engagement assemblies and holding mechanisms than a heavier pan, such as the pan with pan top surface ridged surface shown in FIG. 2C. The frame could have adequate holding mechanisms to accommodate the heaviest pan, which would have the same number of engagement assemblies as the frame has holding mechanisms, but lighter pans could have fewer engagement assemblies if the extra support is unnecessary.

Although shown as pins sliding into slots, the engagement assemblies and holding mechanisms can be any structure or device that secures the pan in the frame, such as but not limited to, a latch, a clamp, etc.

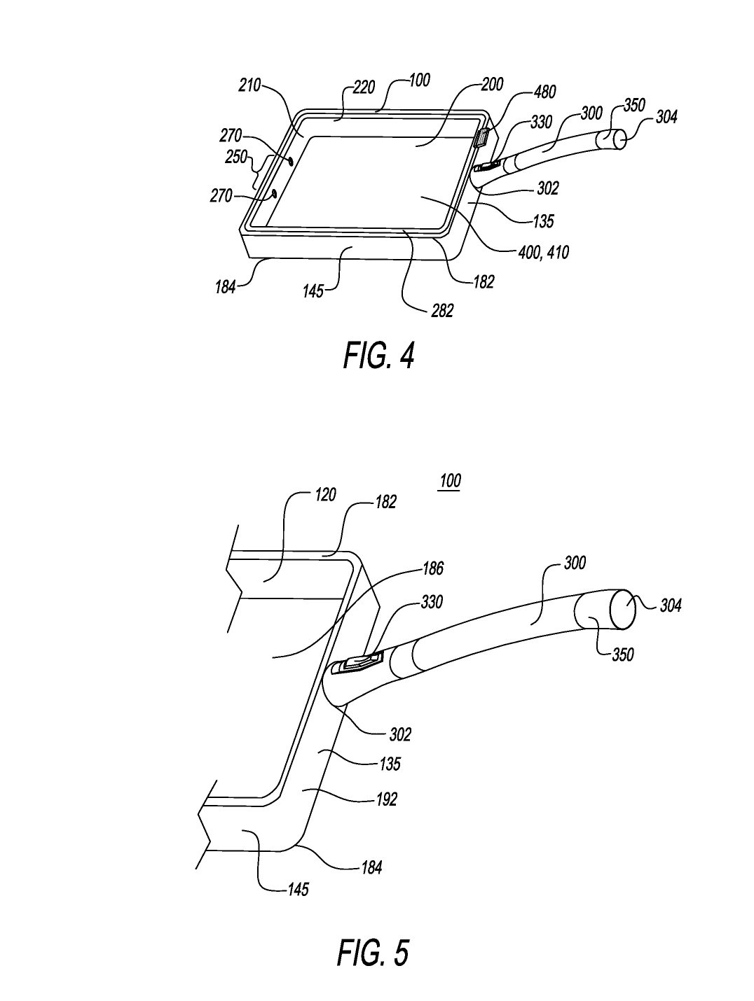

FIG. 4 is top perspective view of the invention in use. FIG. 4 shows frame 100, frame rear outside edge 135, frame left outside edge 145, frame top rim 182, frame bottom rim 184, pan 200, pan front inside edge 210, pan right inside edge 220, pan first engagement assembly 250, pan first engagement assembly interlocking pin 270, pan top rim 282, frame handle 300, handle proximate end 302, handle distal end 304, button 330, temperature gauge 350, pan top surface 400, pan top surface flat surface 410, pan handle 480.

FIG. 4 shows the frame 100 and pan 200 fully contacting each other, with the pan outside edges flush against the frame inside edges. This is a preferred embodiment as it maximizes cooking surface in the pan. The frame and pan edges may or may not contact each other, they may be any distance from each other, from 0.025 inches to 5 inches from each other. The frame would touch the pan only at the first and second holding mechanisms. For instance, the pan first engagement assembly interlocking pins 270 may be of a length such that they engage the frame first holding mechanism interlocking pin receivers when the frame front inside edge is an inch away from the pan front outside edge, and the pan second engagement assembly interlocking pins may be of a length such that they engage the frame second holding mechanism interlocking pin receivers when the frame rear inside edge is an inch away from the pan rear outside edge.

The dimensions of some or all of the pan sides may be smaller than the dimensions of some or all of the frame sides so that some or all of the pan sides don't contact the frame sides. This may be desirable if a user wants to keep the frame edges cool while cooking in the pan.

FIG. 5 is a top exploded view of the handle section of the invention. FIG. 5 shows frame 100, frame right inside edge 120, frame rear outside edge 135, frame left outside edge 145, frame top rim 182, frame bottom rim 184, pan receiving space 186, frame rear side 192, frame handle 300, handle proximate end 302, handle distal end 304, button 330, temperature gauge 350.

FIG. 5 shows a button 330, which may be used to eject a pan from the frame. The button may be connected to a spring loaded device in the handle housing that releases the pan when the button is pushed, or one may push the button to allow the frame second holding mechanism interlocking pin receiver to engage with the pan second engagement assembly interlocking pin 275. The button may be anywhere on the handle, or may be on the frame. FIG. 5 also shows a temperature gauge 350. This may be anywhere on the handle and may be connected to the frame rear outside edge 135 through the handle, or the temperature gauge 350 may be on the frame. Alternately, the temperature gauge 350 may be on the pan or on the pan handle.

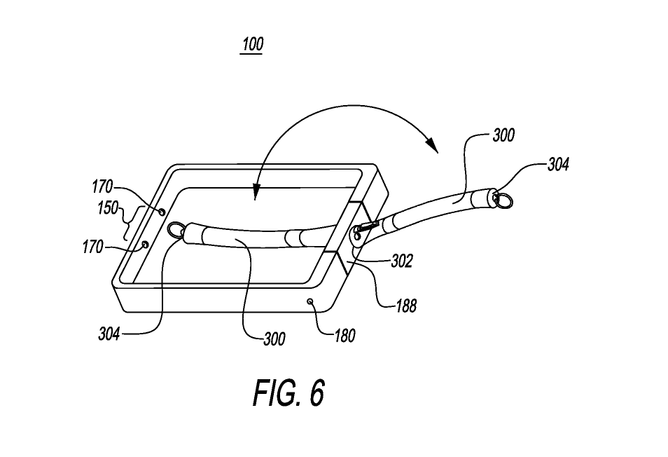

FIG. 6 is a top perspective view of the frame in an alternate embodiment. Only relevant parts have been numbered for purposes of clarity. FIG. 6 shows frame 100, frame first holding mechanism 150, frame first holding mechanism interlocking pin receiver 170, frame additional holding mechanism 180, frame rotatable section 188, frame front side 190, frame rear side 192, frame right side 194, frame left side 196, frame handle 300, handle proximate end 302, handle distal end 304.

FIG. 6 shows how the frame handle 300 is attached to a frame rotatable section 188. This allows the handle to be folded for storage or transport. The frame rotatable section could operate using a hinge or a spring loaded lever. Alternately, the handle could be disposed on a hinge that allows the handle to be folded over the frame while the frame remains stationary. The handle could have a hinge or spring loaded lever activated using a button or other device. This feature is useful for storage of the frame when it's not being used.

FIG. 6 also shows a frame additional holding mechanism 180 that may be used to further the secure the pan in the frame 100. This holding mechanism may be the same as the other holding mechanisms, or it may be a different type.

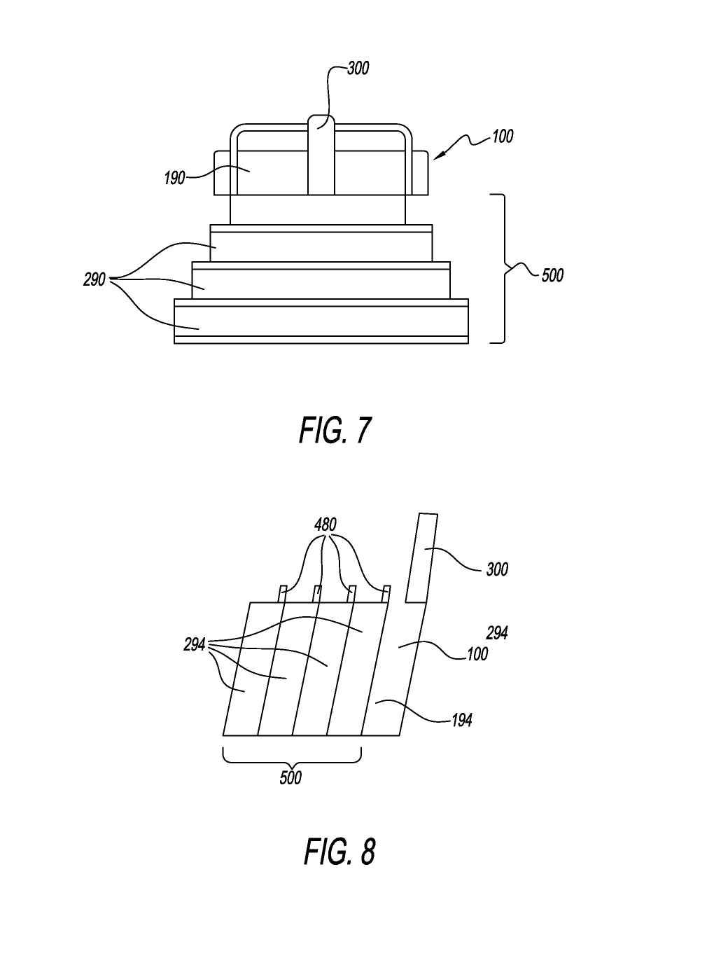

FIG. 7 is a front view of the invention as stored. FIG. 7 shows frame 100, frame front side 190, frame handle 300, and set of pans 500 showing pans front sides 290. A set of pans could be any number of pans from 2 pans to 50 pans, with the preferred number of pans being five. The pans stack and may be disposed on a storage rack.

FIG. 8 is a side view of the invention as stored. FIG. 8 shows frame 100, frame right side 194, frame handle 300, set of pans 500 showing pans right sides 294, and pan handles 480. The frame handle 300 is not folded; it may be folded across the pans and secured to them in a manner that causes the frame and pans to be joined as a bundle that can be easily stored and transported.

Although the figures all show the pans as being the same size and close to the size of the frame, the pans could all be different sizes so that they could nest together for storage. In this case, the same frame could be used for all the pans; as mentioned above in the discussion of FIG. 4, the holding mechanisms and engagement assemblies could be such that they could engage even if the pan was not flush against the frame.

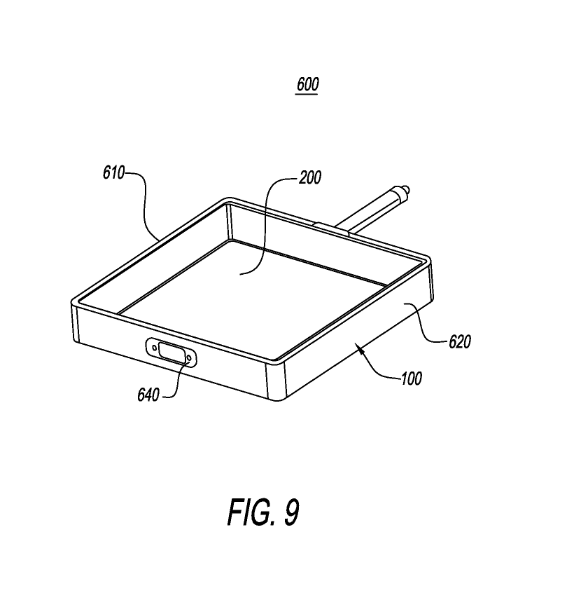

FIGS. 9-13 show an alternate embodiment of the present invention. In a preferred state of this embodiment, the frame may be made of two half-frames, each having a handle end, a logo end and a frame locking pin that is located proximate to the handle ends of the half-frames.

On one side of the frame, a logo plate may join the logo ends of the half-frames to each other. On the other side of the frame, a bridge may join the handle ends of the half-frame together.

A handle, that is preferably hinged, may be attached to one or both of the half-frames. The handle may also have an adjustable locking mechanism for securing and releasing a pan.

The pan may have a base and a surrounding containing element, such as, but not limited to, four vertical sides. The surrounding containing element may be attached to the base. The surrounding containing element may have an upper lip extending outward from the top of the surrounding, containing element, and at least two locating holes. The pan may be configured to fit inside the frame formed by joining the two half-frames. The pan may also be sized so that when the upper lip rests of the pan rests on the top edge of the half-frames, the locating holes align with the locating pins. The locking mechanism may then be adjusted to lock the pan into the frame formed by the two half-frames.

The adjustable locking mechanism may include a locking shaft slidably mounted within the handle. The locking shaft may, for instance, be attached to the handle by means of a screw-thread.

Further in a preferred state of this embodiment, the handle may have an inner handle covered in part by a gripping surface. The locking shaft may be slideably mounted within the inner handle and fixed to the hinged attachment plate in the vicinity of a proximate end of the gripping surface. A locking knob may be attached to the locking shaft in a vicinity of a distal end of the gripping surface.

FIG. 9 is a perspective view of cooking apparatus 600 of the invention having a pan 200 located in a frame, seen from the logo plate 640 side of the frame 100 formed by the two half-frames 610 and 620.

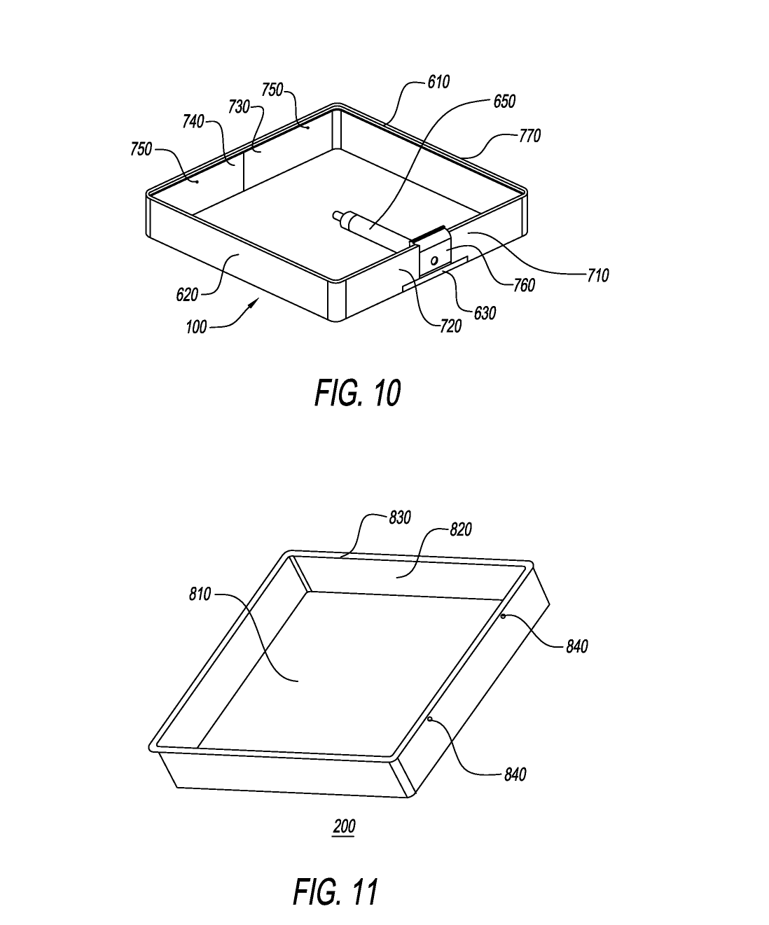

FIG. 10 is a perspective view of an embodiment of a frame 100 of the invention shown with the handle 650 rotated about the hinged attachment plate 760 and in position for storage of the frame 100.

To form the frame 100, the handle end 710 of the first half-frame 610 may be joined to the handle end 720 of the second half-frame 620 by means such as, but not limited to, a bridge 630, while the logo end 730 of the first half-frame 610 may be joined to the logo end 740 of the second half-frame 620 by means such as, but not limited to, a logo plate 640 as shown in FIG. 9. The bridge 630 and the logo plate 640 may effect the joining of the half-frames by being attached to them by a fastening means such as, but not limited to, screws, rivets, welds, glue, interlocking shape, or some combination thereof.

Each of the half-frames 610/620 forming the frame 100 may have a frame locking pin 750. The handle 650 may be secured to a hinged attachment plate 760 that may be attached to the frame 100.

The frame 100 may have a top edge 770 that may have a step down 940 that may run along the full periphery of the top edge 770 of the frame 100.

The dimensions may vary for different types of pans, with preferred dimensions being in the range of 1 inch to 20 inches length per side, 0.1 inch to 10 inches depth per side, and 1/64 inch to 1 inch thick walls for each side. In the case of a complete circular frame, the diameter may range from 1 inch to 25 inches. One preferred embodiment is to have a square shape with dimensions of 11.5 inches length per side, 2 inches deep on each side, and ⅛ inch thick walls for each side.

The frame 100, the pan 200 and their components may be made from any material, including but not limited to: metal, including but not limited to aluminum, stainless steel, and copper; glass and glass products, including but not limited to borosilicate, fiberglass and Gorilla™ glass; plastics; rubbers; textiles; or any material or combinations of these materials with each other or any other materials. The pans 200 may be coated with a non-stick coating such as, but not limited to, Teflon®, or any other material that may be desired as a coating.

FIG. 11 is a perspective view of an embodiment of a pan 200 of the invention.

The pan 200 may have a base 810 and a surrounding containing element 820. The surrounding containing element 820 may have an upper lip 830 that may extend outward from the surrounding containing element 820 and run the full periphery of the surrounding containing element 820.

The surrounding containing element 820 may also have one or more locating holes 840 situated on the outside surface of the pan 200.

In a preferred embodiment, the pan 200 may be configured to fit inside the frame 100. The pan 200 is preferably sized so that when the upper lip 830 rests on the top edge 770 of the frame 100, the locating holes 840 on the outer surface of the pan 200 may align with the corresponding locating pins on the frame 100. The adjustable locking mechanism 900 may then be adjusted to lock the pan 200 to the frame 100 formed by the two half-frames 610/620.

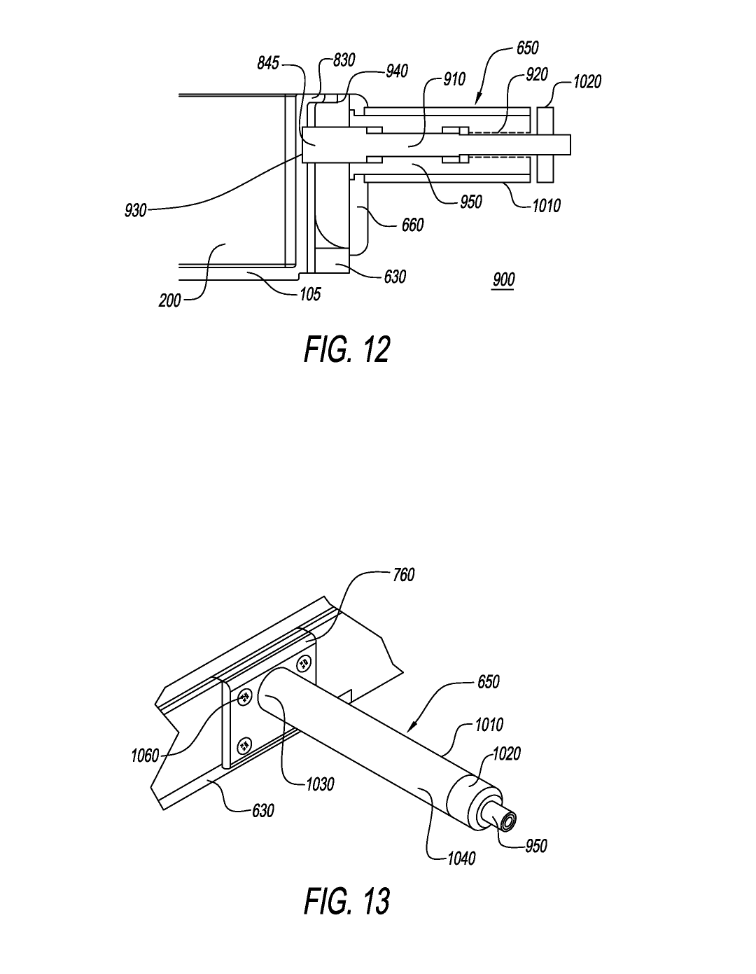

FIG. 12 is a side cross-sectional side view of an adjustable locking mechanism 900 and the handle 650 of an embodiment of the invention. The adjustable locking mechanism 900 may have a locking shaft 910 that may be slidably mounted within the handle 650, so as to be movable along the axis of the handle 650. In a preferred embodiment, the locking shaft 910 is connected to an inner handle 950 by a screw-thread 920. With a screw-thread 920 connection, rotating the locking shaft 910 may cause the contact end 930 of the locking shaft 910 to engage with the corresponding locating indent 845 in the pan 200. The pan 200 may then be displaced horizontally as further rotation of the locking shaft 910 moves the contact end 930 of the locking shaft 910. As the pan 200 is displaced horizontally, the frame locking pins 750 may engage the locating holes 840, thereby locking the pan 200 to the frame 100.

In this arrangement, rotating the locking shaft 910 in the other direction may cause the contact end 930 of the locking shaft 910 to disengage from the locating indent 845 in the pan 200, allowing the frame locking pins 750 to disengage from the locating holes 840, thereby releasing the pan 200 from the frame 100.

FIG. 12 also shows how the upper lip 830 of the pan 200 may rest on a step down 940 on the upper edge of the frame 100. The step down 940 may run the entire periphery of the upper edge of the frame 100.

FIG. 12 also shows the locking knob 1020 that may be attached to the locking shaft 910 to facilitate rotation of the locking shaft 910.

FIG. 12 also shows the bridge 630 that may secure the two half-frames 610/620 together to form the frame 100.

The locking shaft 910, inner handle 950, locking knob 1020 and gripping surface 1010 may be made from any material, including but not limited to: metal, including but not limited to aluminum, stainless steel, and copper; glass and glass products, including but not limited to borosilicate, fiberglass and Gorilla™ glass; plastics; rubbers; textiles; or any material or combinations of these materials with each other or any other materials.

The gripping surface 1010 is, however, preferably made from a non-flammable material having a low heat conductance such as, but not limited to, silicone rubber or other rubber, metal, glass or glass products, high-temperature plastics, or some combination thereof.

FIG. 13 is a perspective close up view showing a handle of one embodiment of the invention. The handle 650 may include a gripping surface 1010 that may have a proximate end 1030 and a distal end 1040. The gripping surface 1010 may be secured to the inner handle 950 by, for instance, gluing or welding or by some attachment means such as, but not limited to, screws, pins or rivets. The handle 650 may be secured to the frame 100 by an attachment means such as, but not limited to, a hinged attachment plate 760. The hinged attachment plate 760 may be fixed to the frame 100 by gluing or welding or by one or more fastening elements 1060 such as, but not limited to, a screw, a rivet, a plug or some combination thereof.

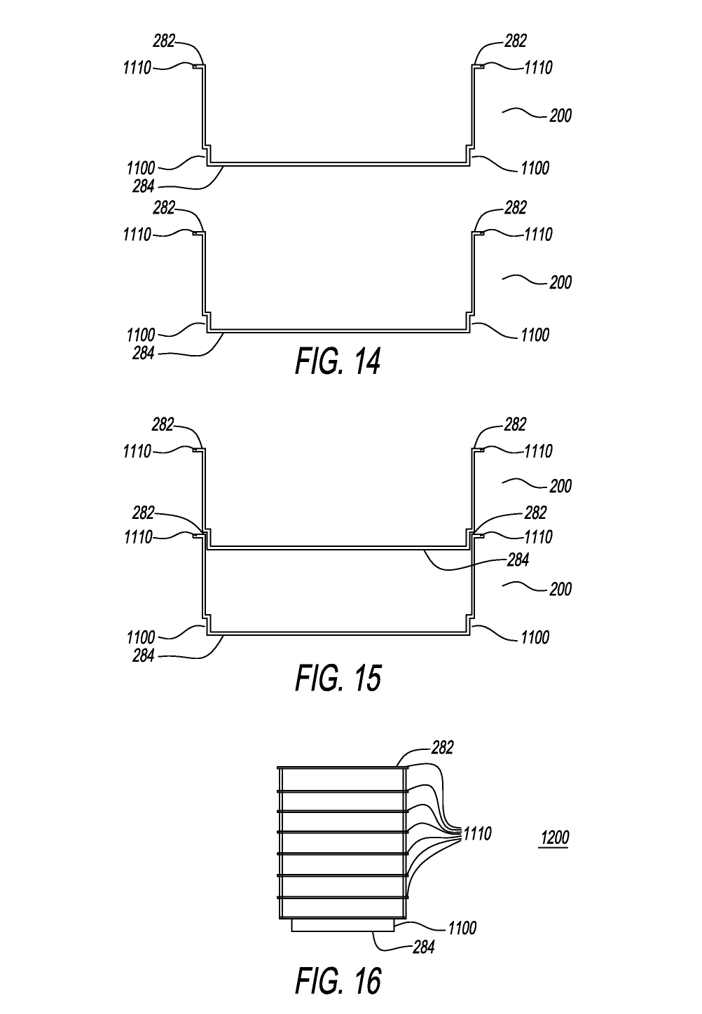

FIGS. 14-19 apply to both embodiments of the present invention disclosed herein.

FIG. 14 and FIG. 15 both show a front view of a set of pans with indentations. FIG. 14 shows the pans before stacking together, and FIG. 15 shows them stacked together. FIG. 14 and FIG. 15 show pan 200, pan top rim 282, pan bottom rim 284, pan indent 1100, and pan top lip 1110. Both figures illustrate the pan indent 1100. This indent allows pans to be nested inside each other for storage. The indent makes the pans fit and lock together so that the stored set of pans is stable and the pans stay nested when stored or transported. The indent can be from 0.1 to 10 inches indented from the side of the pan, with a preferred indent of ¼ inch circumventing the entire pan. The indent dimensions may be the same for all of the pans in a set, or it may vary pan to pan.

FIG. 16 is a back view of a set of stacked pans with indentations. FIG. 16 shows a nesting set of pans 1200, with pan indent 1100 and pan top lip 1110, and pan top rim 282 (for the top pan). As can be seen in FIG. 16, the indent allows the pans to nest together in a compact form. The pan top lip 1110 prevents a pan from sliding too far down into the pan below it. This allows for easier access as the pans don't become stuck together, which would make the upper pan difficult to remove. Thus, one can quickly and easily remove an upper pan from the set of pans, which is important in many instances, as described earlier. The pan top lip may be any shape or size, may be made of the same material as the pan or of a different material, and may have a section or sections that protrude far enough to enable a user to grasp the pan by these sections.

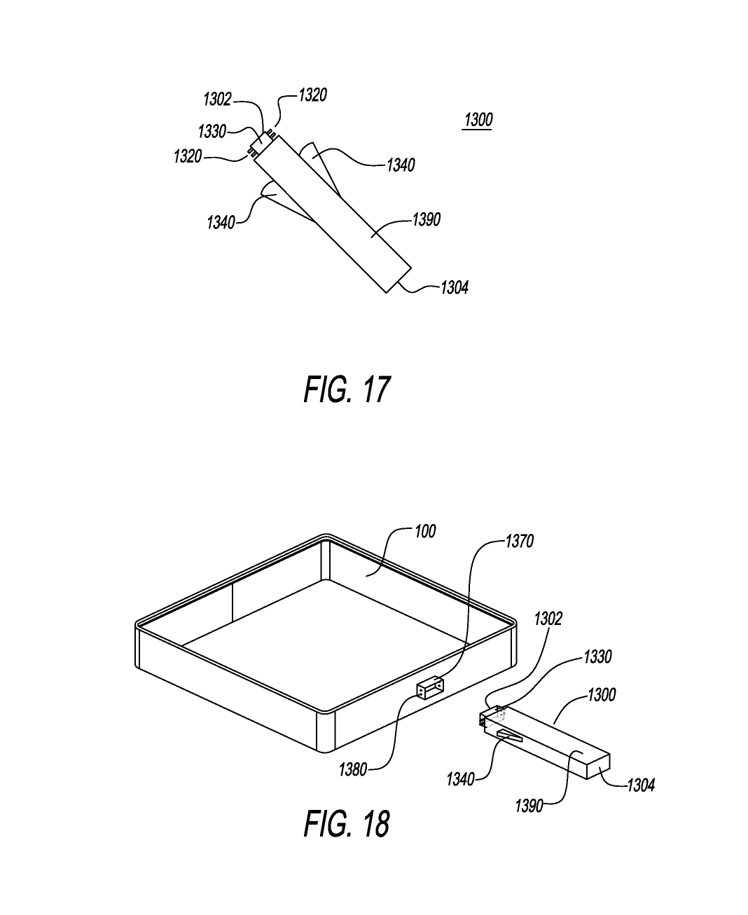

FIG. 17 is a front perspective view of a handle. FIG. 17 shows releasable frame handle 1300, releasable frame handle proximate end 1302, releasable frame handle distal end 1304, handle interlocking pins 1320, handle interlocking pins head 1330, handle interlocking pins compress and release buttons 1340, and releasable frame handle gripping surface 1390.

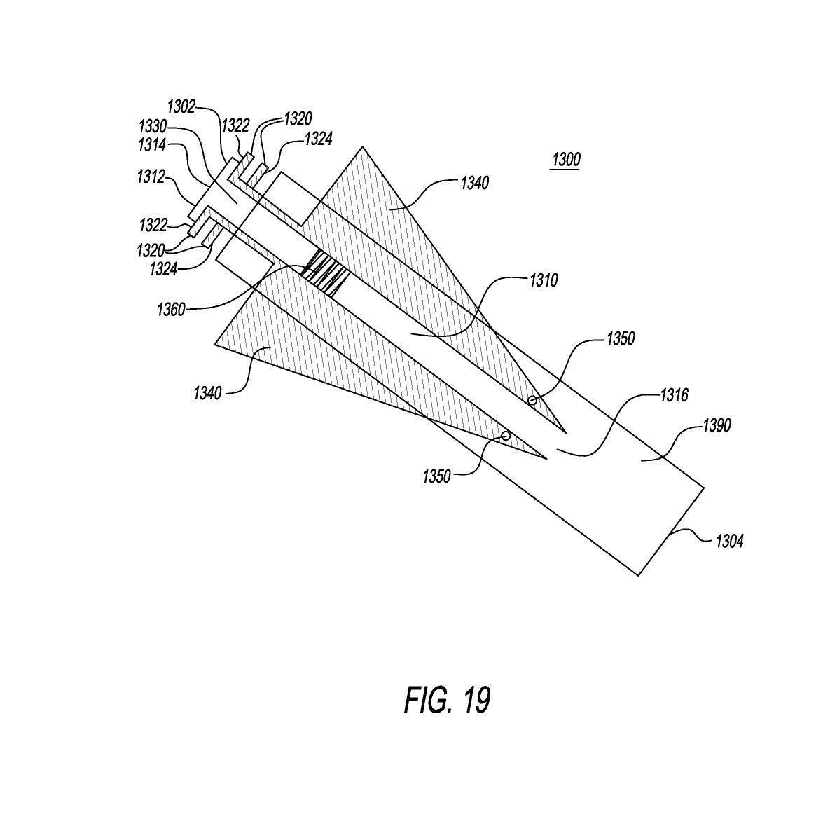

In FIG. 17, the handle interlocking pins are in the position they would be in if engaged in the frame handle pin receptacle (shown in FIG. 18). When the handle interlocking pins are retracted using the handle interlocking pins compress and release buttons 1340, they reside in the handle interlocking pins head 1330. The mechanism of operation will be discussed with FIG. 19.

FIG. 18 is a top perspective view of an embodiment of the invention. FIG. 18 shows frame 100, releasable frame handle 1300, releasable frame handle proximate end 1302, releasable frame handle distal end 1304, handle interlocking pins head 1330, handle interlocking pins compress and release buttons 1340, frame handle pin receptacle 1370, frame handle pin receptacle pin slots 1380, and releasable frame handle gripping surface 1390.

FIG. 18 illustrates how the releasable frame handle 1300, is attached to the frame 100. The handle interlocking pins 1320 (shown in FIG. 17) are retracted by compressing the handle interlocking pins compress and release buttons 1340. The handle interlocking pins head 1330 is lined up with the frame handle pin receptacle 1370, and the head and receptacle are joined by pushing the head into the receptacle. The handle interlocking pins compress and release buttons 1340 are released, and the handle interlocking pins 1320 engage with the frame handle pin receptacle pin slots 1380, thereby locking the releasable frame handle 1300 onto the frame 100.

The user grasps the releasable frame handle 1300 at the releasable frame handle gripping surface 1390 during use. When the user wishes to disengage the releasable frame handle 1300 from the frame 100, he compresses the handle interlocking pins compress and release buttons 1340 to retract the handle interlocking pins 1320 and pulls the releasable frame handle 1300 so that the handle interlocking pins head 1330 is pulled out of the frame handle pin receptacle 1370. The releasable frame handle 1300 may then be stored with the pan or pans, or separately, such as in a drawer or cabinet.

FIG. 19 is a cut-away view of a handle. FIG. 19 shows releasable frame handle 1300, releasable frame handle proximate end 1302, releasable frame handle distal end 1304, handle shaft 1310, handle shaft head 1312, handle shaft proximate end 1314, handle shaft distal end 1316, handle interlocking pins 1320, handle top interlocking pin 1322, handle bottom interlocking pin 1324, handle interlocking pins head 1330, handle interlocking pins compress and release buttons 1340, handle interlocking pins compress and release buttons holding screws 1350, handle spring 1360, and releasable frame handle gripping surface 1390.

FIG. 19 shows how the handle interlocking pins compress and release buttons 1340 function. When the buttons are compressed they compress a handle spring 1360 inside the handle shaft 1310, which causes the handle interlocking pins 1320 to retract into the handle interlocking pins head 1330. The handle interlocking pins compress and release buttons holding screws 1350 hold the buttons in place and are such that they allow the buttons to move when compressed or released. The buttons are also held in place by the handle housing.

FIG. 19 shows handle top interlocking pins 1322, handle bottom interlocking pins 1324; the handle interlocking pins may be configured in this way or may be side by side, circular, or in any way that allows the invention to function. There are four handle interlocking pins shown, but there may be any number of interlocking pins.

The mechanism shown in FIG. 19 is the preferred mechanism, but other mechanisms may be used to join the frame 100 with the releasable frame handle 1300. The mechanism shown in FIG. 19 allows the handle to easily be joined to and removed from the frame. This allows more compact storage of the frame and pans, as they can be stored as a compact unit without a handle protruding and taking up space.

Although the figures all show the frame and pans as being rectangular, one of ordinary skill in the art will readily appreciate that they may have a variety of other shapes such as, but not limited to, square, circular, elliptical, polygonal or some combination thereof.

Although the figures all show the pans as being the same size and close to the size of the frame, the pans could all be different sizes so that they could nest together for storage.

Although the use of the invention has been discussed primarily with stovetops as the heat source for cooking food, it may also be used in any type of oven or over a fire or with any other heat source.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. An article of manufacture comprising:
A frame, having inside and outside edges;
A first holding mechanism located on a first portion of the inside edge;
A second holding mechanism located on a second portion of the inside edge;
A handle, disposed on the frame;
At least one pan having a first engagement assembly which may engage the first holding mechanism and a second engagement assembly which may engage the second holding mechanism, wherein the second engagement assembly has open and closed positions and the pan is secured to the frame when the second engagement assembly is in the closed position and the pan may be removed from the frame when the second engagement assembly is in the open position.

2. The article of claim 1, wherein said pan has sides and a bottom rim, and said bottom rim is indented relative to said sides.

3. The article of claim 1, wherein said handle is releasably attached to said frame.

4. The article of claim 1, wherein the frame is a complete square.

5. The article of claim 1, wherein the frame is a complete circle.

6. The article of claim 4, wherein the frame has a front, rear, and left and right sides, and the first holding mechanism is at the front side of the frame and the second holding mechanism is at the rear side of the frame.

7. The article of claim 1, wherein handle is disposed on a hinge that allows the handle to be folded over the frame.

8. The article of claim 1, wherein the first holding mechanism and the first engagement assembly comprise interlocking pins and pin receivers.

9. The article of claim 1, wherein second engagement assembly and the second holding mechanism comprise a pin and receiver assembly which is activated by a spring loaded lever.

10. The article of claim 1, further comprising at least one additional holding mechanism and one additional engagement assembly.

11. The article of claim 1, wherein the frame has a rotatable section, and the handle is attached to the rotatable section.

12. The article of claim 1, wherein the pan has a top surface, said top surface being flat or having a waffle, egg, texture, or ridged surface, or combinations thereof.

13. The article of claim 12, wherein the pan top surface is coated with a non stick coating.

14. The article of claim 1, comprising a set of at least 2 pans.

15. The article of claim 14, wherein the set is disposed on a storage rack.

16. The article of claim 1, wherein the frame has a front, rear, and left and right sides, and the first holding mechanism is at the left side of the frame and the second holding mechanism is at the right side of the frame.

17. The article of claim 1, wherein the frame is a complete or partial circle, triangle, rectangle, oval or square.

18. The article of claim 1, wherein frame touches the pan only at the first and second holding mechanism.

19. A cooking apparatus, comprising:
a first half-frame, and second half-frame, each having a handle end, a logo end and a frame locking pin located proximate to said handle ends;
a logo plate configured to join said logo end of said first half-frame to said logo end of said second frame;
a bridge configured to join said handle end of said first half-frame to said handle end of said second frame;
a handle attached to one or both of said first and second half-frames, said handle having an adjustable locking mechanism; and
a pan having a base and a surrounding containing element attached to said base, an upper lip extending outward from the top of said surrounding, containing element, and at least two locating holes, said pan being configured to fit inside said joined first and second half-frames such that when said upper lip rests on a top edge of said half-frame, said locating indents align with said locating holes and said locking mechanism adjusts to lock said pan to said half-frames.

20. The apparatus of claim 19 further comprising a hinged attachment plate fixed to said frame, and wherein said handle is attached to said hinged attachment plate.

21. The apparatus of claim 19 wherein said adjustable locking mechanism further comprises a locking shaft slidably mounted within said handle.

22. The apparatus of claim 19 wherein said handle further comprises an inner handle, a gripping surface covering a part of said inner handle and affixed thereto, a locking knob attached to locking shaft in a vicinity of the distal end of said gripping surface, and wherein said inner handle is attached to said hinged attachment plate in a vicinity of a proximate end of said gripping surface.

23. The apparatus of claim 21 when said locking shaft attaches to said handle via a screw-thread.

24. The apparatus of claim 19, wherein said pan has sides and a bottom rim, and said bottom rim is indented relative to said sides.

25. The apparatus of claim 19, wherein said handle is releasably attached to said frame.
